(19) United States
(12) Patent Application Publication
(10) Pub. No.: US 2025/0058336 A1
(43) Pub. Date: Feb. 20, 2025

(54) Spraying member and rotary coating product projector comprising such a spraying member

(71) Applicant: EXEL INDUSTRIES, EPERNAY (FR)

(72) Inventors: Denis VANZETTO, EPERNAY (FR); Joseph TARANTINI, LA TERRASSE (FR); Sylvain PERINET, Giez (FR)

(21) Appl. No.: 18/796,299

(22) Filed: Aug. 7, 2024

(30) Foreign Application Priority Data
Aug. 14, 2023 (FR) 2308704

(51) Int. Cl. B05B 3/10

(52) U.S. Cl. CPC B05B 3/1042; B05B 3/1014

(57) ABSTRACT

A spraying member for a coating product rotary projector which carries at least one mechanical locking weight on a drive shaft of the rotary projector. The weight is movable, radially to the central axis of the bowl and according to a centrifugal direction relative to this axis, between an unlocked position, in which it does not oppose the mounting of the spraying member on the drive shaft or its dismantling relative to this shaft, and a locked position, in which it opposes the dismantling of the bowl relative to the drive shaft.

### CROSS-REFERENCE TO RELATED APPLICATION

This application is a U.S. non-provisional application claiming the benefit of French Application No. 23 08704, filed on Aug. 14, 2023, which is incorporated herein by reference in its entirety.

### TECHNICAL FIELD OF THE INVENTION

The present invention relates to a spraying member for a coating product rotary projector, as well as to a coating product rotary projector comprising such a spraying member.

### BACKGROUND OF THE INVENTION

In the field of coating product spraying, it is known, for example from WO2005/082542A, of a spray bowl equipped with first magnetic coupling means able to cooperate with complementary second magnetic coupling means, fixed to a non-rotating part of a projector. These first and second coupling means exert an axial force relative to an axis of rotation of the bowl, which induces a coupling in rotation of the bowl and a corresponding drive member.

Overall, this equipment is satisfactory.

However, one problem with this equipment is that the magnetic force between the first and second coupling means must be intense to ensure that the bowl remains in place on the projector, even though the latter may be subjected to significant accelerations when mounted at the end of the arm of a multi-axis robot. This problem is all the more crucial when the bowl presents a high mass.

The intensity of the magnetic force between the first and second magnetic coupling means makes it difficult to dismantle the bowl during maintenance operations. In addition, this high magnetic force can be dangerous if a finger of the operator gets caught when mounting the bowl on the projector.

Similar problems arise with disc-type spraying members, in other words, spraying members presenting an edge, the diameter of which is generally between 120 and 500 mm. They are exacerbated due to the relatively high mass of these discs.

Similar problems also arise with spraying members mounted on rotating shafts by coupling means other than magnetic ones, in particular by screwing, clipping or quarter-turn locking.

On the other hand, it is known from DE102017212480A1, DE102021127163A1 and DE102017102965A1 to mount locking members on a drive shaft of a spraying member. These locking members, mounted on the drive shaft, tend to wear out as they cooperate successively with several bowls. They also make balancing the drive shaft relatively complex. Finally, if one of these locking members malfunctions, it is necessary to dismantle the drive shaft, which constitutes a relatively complicated and time-consuming operation.

### SUMMARY OF THE INVENTION

It is to these disadvantages that the invention more particularly intends to remedy by proposing a new spraying member, which may be of the bowl, disk or other type, the mounting of which on a coating product rotary projector is made more reliable, without necessarily having to use coupling means inducing an intense coupling force.

To this end, the invention has as its object a spraying member for a coating product rotary projector, characterized in that it carries at least one mechanical locking weight on a drive shaft of the rotary projector, the weight being movable, radially to the central axis of the bowl and according to a centrifugal direction relative to this axis, between
an unlocked position, in which it does not oppose the mounting of the spraying member on the drive shaft or its dismantling relative to this drive shaft; and
a locked position, where it opposes dismantling of the bowl relative to the drive shaft.

Thanks to the invention, the weight(s) allow(s) the centrifugal force inherent in the movement in rotation of the spraying member about its axis of rotation to be used to lock the spraying member to the drive shaft. The passage of the or each weight from its unlocked position to its locked position takes place automatically when the bowl is rotated about its axis of rotation. In addition, the weights being provided on the spraying member, the drive shaft can be devoid of moving parts, which facilitates its balancing and increases its service life relative to the case where it would carry locking members.

Within the scope of the present invention, a spraying member for a coating product rotary projector can be a bowl, a disk or any other member intended to be driven in rotation to spray a liquid or powder coating product. Such a spraying member may also be referred to as a bell or cup.

Given the locking function obtained with the weights(s), a magnetic or mechanical coupling force between the bowl and a drive shaft can be reduced, relative to prior art equipment.

In addition, the reduction in magnetic force makes it easier to dismantle the spraying member during maintenance operations and reduces the risk of pinching the fingers of the operator.

In the particular case of spray discs, securing the mounting of the disc onto the drive shaft allows a conventional drive turbine to be used, of the same type as that used for bowls, the diameter of which is generally between 10 and 100 mm.

According to advantageous but non-mandatory aspects of the invention, such a spraying member can incorporate one or more of the following features taken according to any technically permissible combination:
The spraying member is equipped with a first magnetic coupling means configured to cooperate with complementary second magnetic coupling means to exert a force, at least partially axial, relative to a central axis of the bowl.
The spraying member comprises a number of weights distributed about the central axis, preferably in a regular pattern.
The spraying member comprises a hub, while each weight is received in a housing formed in the hub and which opens onto an external radial surface of the hub and that,
   in its unlocked position, the weight is completely enclosed in the housing; and
   in its locked position, the weight projects from the housing, beyond the external radial surface of the hub.
A hole through which the housing opens onto the external radial surface of the hub is dimensioned to prevent the weight from exiting the housing through this hole.
Each weight comprises a segment bearing axially against the drive shaft, and the housing comprises a portion of a groove arranged on the external radial surface of the hub and which extends, preferably, according to a direction orthoradial to the central axis of the bowl, on either side of another portion of the housing in which a guide heel for the weight is engaged.
The spraying member comprises a hub and each weight is formed by a part integral with the hub and movable from its locked position and toward its unlocked position by elastic deformation of a part of the hub, under the effect of inertia, when the spraying member is driven in rotation about its central axis.
The spraying member comprises a means of elastically returning the weight toward its unlocked position.
The elastic return means is an elastically deformable ring which surrounds a hub of the spraying member, at the weight(s) along the central axis of the bowl.
The elastically deformable ring bears against an external radial surface of each segment.

According to a second aspect, the invention also relates to a coating product rotary projector comprising a spraying member, and a shaft for driving in rotation the spraying member about an axis of rotation and second magnetic coupling means configured to cooperate with first magnetic coupling means of the spraying member, characterized in that the spraying member is such as mentioned above and in that each weight is brought into its locked position due to the rotation of the spraying member by the drive shaft.

Advantageously, the drive shaft defines a bearing relief for the or each weight of the spraying member in the locked position and in that, preferably, the bearing relief is an internal shoulder of the drive shaft.

### BRIEF DESCRIPTION OF THE DRAWINGS

The invention will become clearer from the following description, which is given only as a non-limiting example, with reference to the drawings in which:

FIG. 1 is a principle partial axial cross section of a projector in accordance with the invention and shows, in external view, a spray bowl in accordance with the invention being mounted on this projector;

FIG. 2 is a principle partial axial cross section of the projector and bowl of FIG. 1;

FIG. 3 is a view corresponding to detail III in FIG. 2 for a projector and bowl in accordance with a second embodiment of the invention, in a first configuration of use;

FIG. 4 is a cross section and perspective view of part of the bowl of the second embodiment in the configuration of FIG. 3;

FIG. 5 is a view similar to FIG. 3, when the projector and bowl are in a second operating configuration;

FIG. 6 represents, on several inserts A), B), C) and D), an axial cross section with a zoom of a detail, a side view, a perspective cross section and a partial view of a spray disc in accordance with a third embodiment of the invention, in a first configuration of use; and

FIG. 7 represents the inserts A), B), C) and D) of the same spray disc in a second configuration of use.

### DETAILED DESCRIPTION

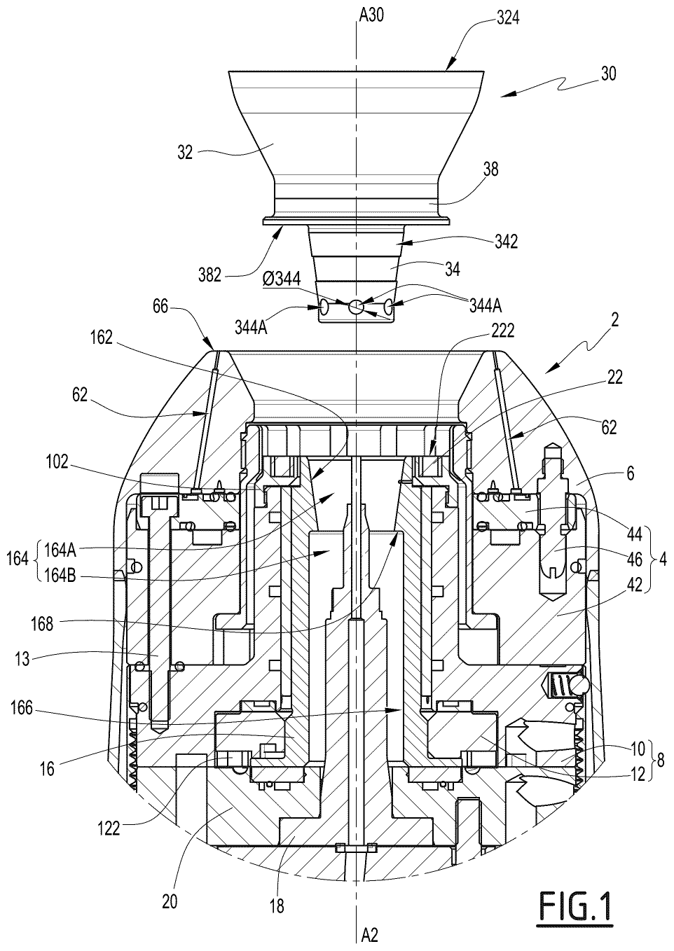

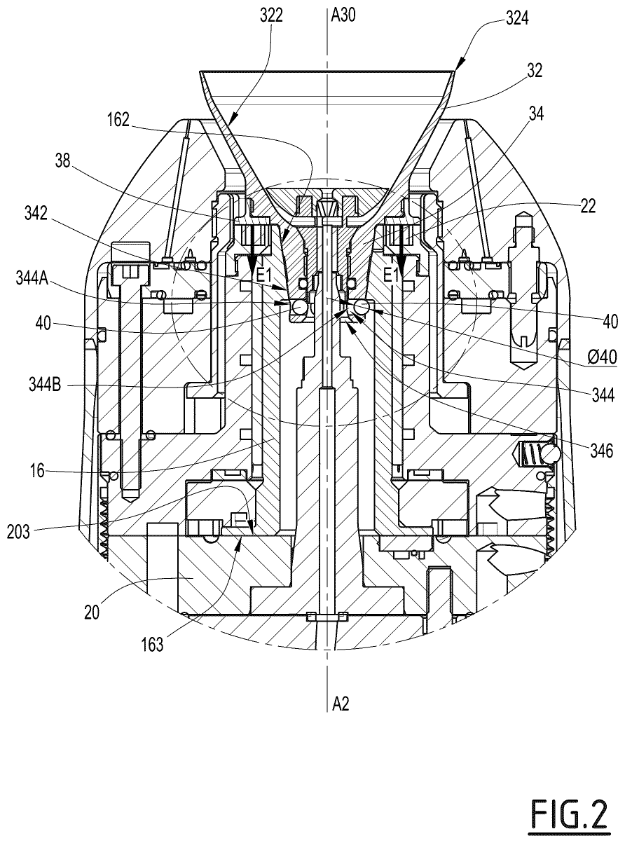

The rotary coating projector 2 represented in FIGS. 1 and 2 extends along a longitudinal axis A2 and comprises a body 4 formed by a principal part 42 and a plate 44 for distributing air toward an air supply skirt 6 on a face 66 of the skirt 6, into which open the channels 62 arranged in the air skirt 6. The front face 66 of the air supply skirt 6 is also a front face of the projector 2.

For example, the coating product is a liquid paint, a primer or a varnish intended to be applied to a bodywork or a component of a motor vehicle.

The projector 2 is of the internally charged electrostatic type and comprises a high-voltage unit, not shown, configured to raise to a given electric potential the coating product sprayed by the projector 2.

A front side of the projector 2 or a component of the projector is defined as a side turned toward a workpiece to be coated, when the projector 2 is in use, and a rear side as a side turned opposite to the front side. In FIGS. 1 and 2, the front of the projector 2 is turned upward and the rear is turned downward.

The pins 46 allow to secure and orientate the elements 42, 44 and 6 relative to one another.

The projector 2 also comprises an air turbine 8 which itself includes a stator 10 and a rotor 12 which carries the blades 122 subjected to the action of an air flow driving the rotor 12 in rotation about the longitudinal axis A2.

The body 4 and the stator 10 are secured by means of the screws 13 which pass through the elements 44, 42 and 10.

A rotating shaft 16 is secured to the rotor 12 and turns with it about the longitudinal axis A2, which forms an axis of rotation for the rotor 12 and the rotating shaft 16.

The rotating shaft 16 is equipped with a frustoconical surface 162 centered on the longitudinal axis A2 and diverging toward the front.

The rotating shaft 162 is hollow and defines a central bore 164 in which a coating product injector 18 is arranged, supported by a plate 20 on which the body 4 and the turbine 8 of the projector 2 are mounted. The stator 10, which does not turn about the axis A2 when the projector 2 is in use, is equipped with a support 102 on which an annular permanent magnet 22 is mounted, centered on the longitudinal axis A2.

A central bore 164 of the rotating shaft 16 comprises a first front portion 164A defined radially by the frustoconical surface 162 and a second rear portion 164B defined by a circular-based cylindrical surface 166, also centered on the axis A2.

The minimum diameter of the frustoconical surface 166 is less than the diameter of the cylindrical surface 166. Thus, a shoulder 168 turned toward the rear is defined in the bore 164, at the junction between its front and rear portions 164A and 164B.

A spray bowl 30 in accordance with the invention is provided to be mounted on the projector 2. The spray bowl 30 is centered on a central axis A30 which coincides with the longitudinal axis of rotation A2 in a mounted configuration of the bowl 30 on the projector 2.

The spray bowl 30 comprises a front portion 32, which defines a surface 322 for distributing a liquid coating product to a spray edge 324 forming a front end of the bowl 30. The spray bowl 30 also comprises a hub 34 intended to be engaged in the central bore 164 of the rotating shaft 16. An external peripheral surface 342 of the hub 34 is configured to come to bear against the frustoconical surface 162 of the rotating shaft 16, thus ensuring that the spray bowl 30 and the rotating shaft 16 are secured in rotation about the coincident axes A2 and A30.

The spray bowl 30 is equipped with a deflector 36 which is screwed into the hub 34 and which allows to deflect a flow of liquid coating product leaving the injector 18 toward the distribution surface 322.

The spray bowl 30 is also equipped with a ring 38 made of a ferromagnetic material and intended to interact with the magnet 22.

For example, the ring 38 may be made of steel, while the front portion 32 and the hub 34, which are integral, are made of aluminum.

In an alternative of the invention, not shown, the front portion 32 and/or the hub 34 are made of a ferromagnetic material and a part corresponding to the ring 38 is integral with one or other of these elements.

The ring 38 defines an annular surface 382 perpendicular to the central axis A30, which is arranged facing the permanent magnet 22 when the bowl 30 is in the mounted configuration on the projector 2.

In this configuration, a magnetic flux from the permanent magnet 22 closes in the ferromagnetic material ring 38, which has the effect of exerting a coupling force E1 generally parallel to the coincident axes A2 and A30, this having the effect of firmly pressing the external peripheral surface 342 against the frustoconical surface 162, thus securing, in rotation, the spray bowl 30 and the rotating shaft 16.

During operation of the projector 2, and insofar as the permanent magnet 22 is fixed relative to the body 4, while the spray bowl 30 must be able to turn, an axial gap must be created between the elements 22 and 38, which is obtained by injecting a flow of air between a rear surface 163 of the rotating shaft 16 and a front surface 203 of the plate 20, which has the effect of creating an air bearing between the parts 16 and 20. For clarity of the drawing, this air bearing is not shown in FIG. 2, where the surface 382 is shown bearing on a front surface 222 of the magnet 22.

To sum up, the ring 38 forms the first magnetic coupling means and the permanent magnet 22 forms the second magnetic coupling means which allows the magnetic force E1 to be exerted, which is axial and induces a coupling of the bowl 30 and the rotating shaft 16 in rotation, while an air flow, not shown, allows an air bearing to be created between the rotating shaft and a fixed part of the projector 2, which has the effect of pushing the rotating shaft 16 and the bowl 30 carried by the rotating shaft forward. As a result, an axial gap is created between the surfaces 222 and 382, allowing the bowl 30 to rotate about the axis of rotation A2.

Here, the force E1 is purely axial relative to the axis of rotation A2. In one alternative of the invention, not shown, the force E1 is partially axial relative to this axis of rotation, in other words, inclined relative to it, as envisaged in WO2005/082542A.

The hub 34 is pierced by six recesses 344 which open onto the peripheral surface 342, each through a first hole 344A.

Inside each of the housings 344 is arranged a weight 40 which, in the example of FIGS. 1 and 2, is a ball the diameter of which is noted Φ40.

Each first hole 344A is circular in shape and its diameter is noted Φ344.

The diameter Φ344 is slightly less than the diameter Φ40, for example, by 10%, so that the balls 40 do not risk being ejected from the housings 344 through the first holes 344A, even under the action of centrifugal force when the spray bowl is driven in rotation about the axis of rotation A2 by the rotating shaft 16.

In the case of a weight 40 presenting, alternatively, a non-circular shape, the geometry of the housing 344 and the hole 344A are adapted. In all cases, the dimensions of the hole 344A prevent the weight 40 from exiting the housing 344 through this hole.

On the other hand, each housing 344 opens, through a second hole 344B, into a central bore 346 of the hub 34 opposite its first hole 344A. When it is screwed into the hub 34, the deflector 36 partially closes each second hole 344B, so that the weights 40 cannot leave their housing 344 by fully engaging in the central bore 346.

At rest, in other words, when the turbine 8 is not in operation, the spray bowl 30 does not turn about the axis of rotation A2, and the weights 30 can assume any position in their housing 344, between the holes 344A and 344B. In particular, they can be fully engaged in these housings 344, as shown on the left of FIG. 2, in which case they do not oppose the placing of the spray bowl 30 on the rotating shaft 16 nor at its removal.

During operation of the spraying member 2, when the spray bowl is driven in rotation about the axis of rotation A2, at a speed of several thousand revolutions per minute, the centrifugal force exerted on the weights 40 has the effect of displacing them to the configuration shown on the right of FIG. 2, where each of these weights projects, through the first hole 344A of the corresponding housing 344, relative to the peripheral surface 342.

In the embodiment in FIGS. 1 and 2, the housings 344 each extend according to a direction radial to the central axis A30 and perpendicular to this axis. The weights displace according to this direction.

In one alternative of the invention, not shown, the housings extend according to the directions inclined toward the front of the bowl 3, according to which the weights 40, under the effect of the centrifugal force are displaced. Advantageously, an angle of inclination between the longitudinal directions of the housings 344 and a plane perpendicular to the central axis A30 is between 0 and 45°, preferably between 0 and 30°.

By projecting in this way relative to the peripheral surface 342, each weight 40 comes to face the shoulder 168, in such a way that it opposes extraction of the bowl 30 relative to the rotating shaft 16, in a direction opposite to that of the force E1.

Thus, the weights constituted by the balls 40 secure the bowl 30 to the rotating shaft 16 as soon as the rotating projector 2 drives the bowl 30 in rotation about its axis of rotation A2. A mechanical locking force due to the interaction of the balls 40 and the shoulder 168 is thus added to the magnetic force E1 between the first and second magnetic coupling means 38 and 22, when the spraying bowl 30 is driven in rotation by the rotating shaft 16, about the axis of rotation A2. The intensity of the magnetic force E1 may therefore be reduced relative to the intensity of a force of the same type in prior art equipment.

Under these conditions, the operation of the projector 2 is reliable and the mounting of the spray bowl 30 on the rotating shaft 16 is durable, even if the magnet 22 develops a magnetic force of relatively low intensity on the ferromagnetic ring 38. The use of the weights 40 therefore allows the size, mass and cost of the permanent magnet 22 to be reduced, as well as the air flow required to create an air bearing between the surfaces 222 and 382.

When the projector 2 is switched off, the centrifugal forces no longer apply to the weights 40, which can then resume a position such as that shown on the left of FIG. 2, where they do not oppose the extraction of the spray bowl 30 relative to the rotating shaft 16, under the effect of a force inverse to the magnetic force E1.

As this magnetic force E1 is less important than in the prior art, due to less magnetic interaction between the elements 22 and 38, the force required to withdraw the spray bowl 30 is less important.

In addition, as the magnetic force E1 between the elements 22 and 38 is less important than in the prior art, there is less risk of injury to the user when fitting the spray bowl 30 to the projector 2, in particular, by pinching the finger under the effect of the attraction between the parts 22 and 38.

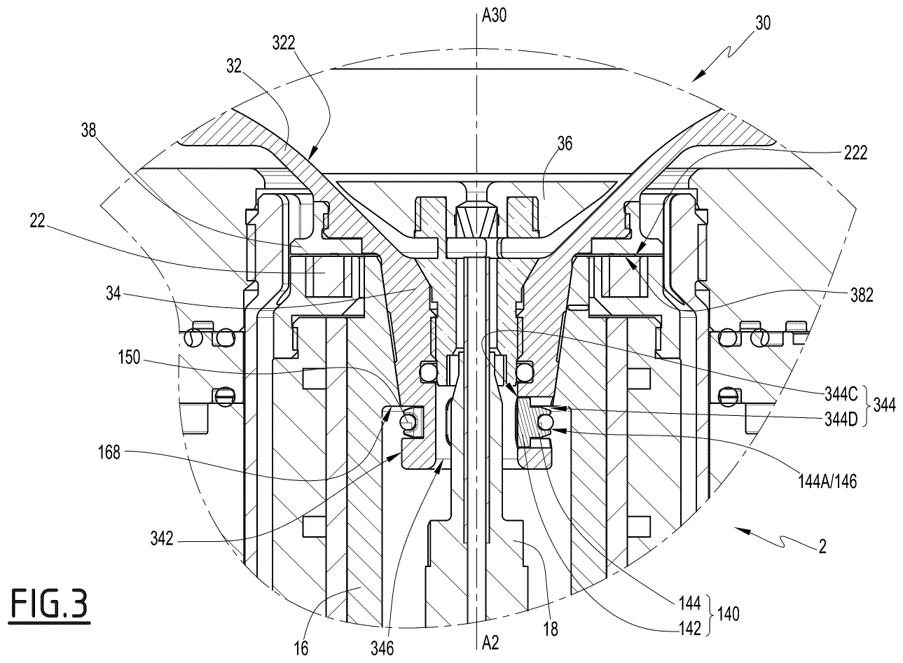

In the second and third embodiments of the invention shown in FIG. 3 and following, elements similar to those in the first embodiment carry the same references. In what follows, if a reference is mentioned in the description without being carried on one of FIGS. 3-7 or carried on one of these figures without being mentioned in the corresponding description, it designates the same element as in the first embodiment.

In the foregoing, it is mainly described what distinguishes the second embodiment from the first embodiment.

In the second embodiment, the balls 40 of the first embodiment are replaced by weights 140, each comprising a heel 142 and an arcuate segment 144.

Each heel 142 is oblong in shape, with its longest dimension parallel to the central axis A30 when the weight is in the mounted configuration on the bowl 30. Each segment 144 extends over an angular amplitude of approximately 120° about the axis A30 in the mounted configuration of the weight 40 on the bowl 30.

In the example shown in FIGS. 3-5, the bowl 30 is equipped with three weights, hence the value of 120° for the angular amplitude of the segments 144.

Alternatively, the number of weights 140 is different, for example equal to one, two, four or six, in which case the angular amplitude of segments 144 is adapted, for example equal to 180°, 90° or 60°.

Preferably, the number of weights 40 is strictly greater than one and they are distributed about the central axis A30.

In this case, the weights are advantageously evenly distributed about the central axis A30, which allows to balance a locking force of the bowl 30 on the rotating shaft, obtained with these weights and explained below.

Each weight 140 extends into a housing 344 comprising a first central portion 344C, which passes right through the hub 34 and is intended to receive the heel 142, and a second peripheral portion 344D, in the form of a peripheral groove segment arranged on the peripheral surface 342 of the hub 344 and which is intended to receive the segment 144.

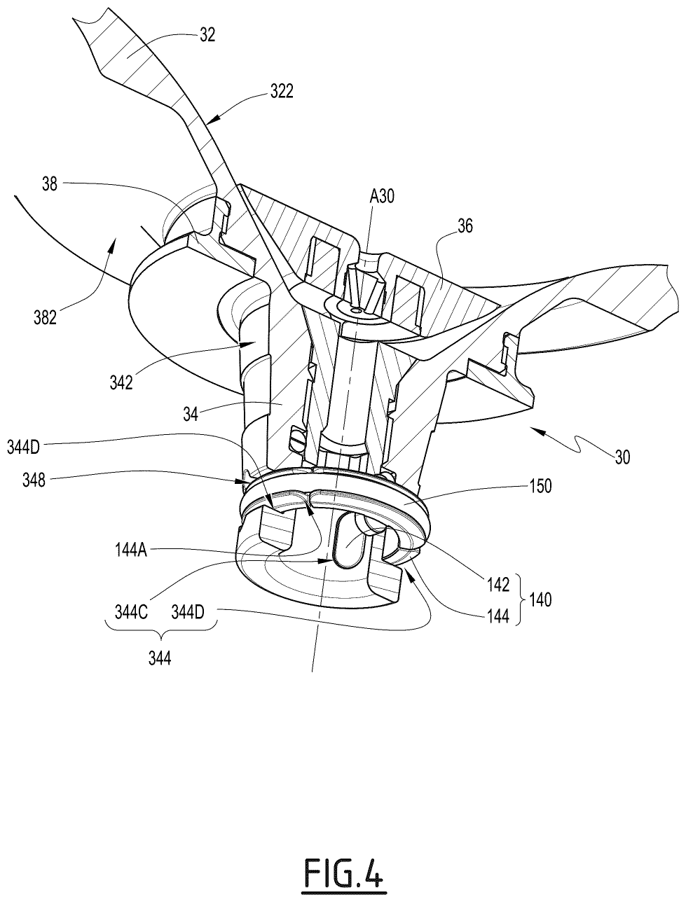

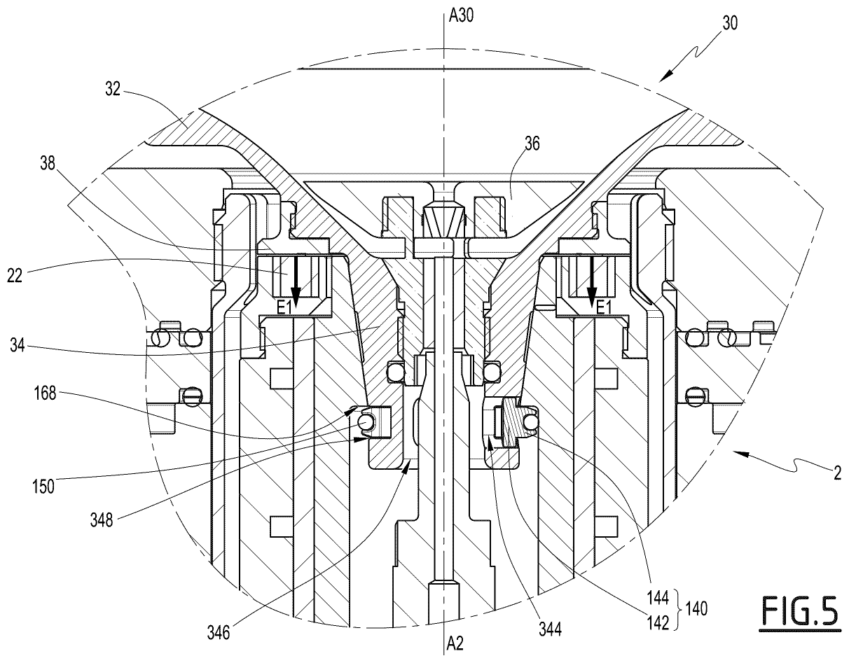

In other words, the three segments 144 of the three weights 140 which equip the bowl 30 in the embodiment of FIGS. 4 and 5 together occupy an external annular groove 348 of the hub 34, this peripheral groove 348 extending 360° about the central axis A30 and being formed by the joining of the three second portions 344D of the three housings 344 configured to receive the segments 144.

The cooperation of the portions 344C and the heels 142 allows each weight 140 to be guided in translation according to a direction radial to the axis A30.

Each segment 144 is provided with an external peripheral groove 144A which extends over the entire angular amplitude of the segment. The combination of the peripheral grooves 144A forms an annular groove 146, which extends over 360° about the central axis A30.

On the other hand, an O-ring 150 is engaged in the annular groove 146.

The O-ring 150 surrounds the hub 34 of the spray bowl 30, at the level of the weights 140 and the housings 344. It bears against the bottom of the annular groove 146, which is formed by the joining of the bottoms of the outer peripheral grooves 144A of the segments 144, which are external radial surfaces for these segments.

The diameter of the seal 150 is chosen so that, by default, it presses the weights 140 toward their deepest position in the housings 344, this position being that shown in FIGS. 3 and 4. In this position, the internal radial surfaces of the segments 144 bear against the bottoms of the second portions 344D of the three housings 344.

In this position, the weights 140 and the O-ring 150 do not project radially beyond the peripheral surface 342 of the hub 34, so that the weights 140 do not oppose the mounting of the spray bowl 30 on the projector 2 or its dismantling.

In this position, the weights 140 are each in an unlocked position.

When the projector 2 operates and drives the spray bowl 30 in rotation about the axis of rotation A2, the weights 140 are subjected to the centrifugal forces and are displaced radially to the axis A2, within the housings 344, to reach the configuration shown in FIG. 5, where their segments 144 project radially from the external peripheral surface 342 of the hub 34 and are aligned, according to a direction parallel to the axis A2, with the internal shoulder 168 of the rotating shaft 16.

Thus, according to whether the bowl 30 is driven in rotation or not, the segments 144 come selectively to face the shoulder 168 and, where appropriate, bear against it. The segments 144 are the segments bearing axially against the drive shaft 16.

In this configuration, the weights 140 oppose a pull-out movement of the bowl 30 relative to the rotating shaft 16, in a direction opposite that of a magnetic force E1 defined as in the first embodiment.

As soon as rotation of the bowl 30 is stopped, the elastic force applied by the O-ring 150 to the weights 140 returns these weights to their unlocked configuration shown in FIGS. 3 and 4. The O-ring 150 therefore ensures that the weights return to their unlocked configuration as soon as rotation of the bowl 30 is stopped.

Furthermore, it is not necessary for the housings 344 to present openings on the peripheral surface 342 with dimensions less than the dimensions of the weights 140, since the seal 150 opposes complete removal of the weights 140 relative to these housings.

On the other hand, the shape of the segments 144, which have a width according to a direction orthoradial to the central axis A30 that is greater than the orthoradial dimension of the portions 344C, opposing migration of the weights 144 toward the central bore 346.

In this respect, the fact that the sum of the angular sectors over which the various segments 144 extend is approximately equal to 360° also allows to oppose the weights 144 from engaging in the central bore 346.

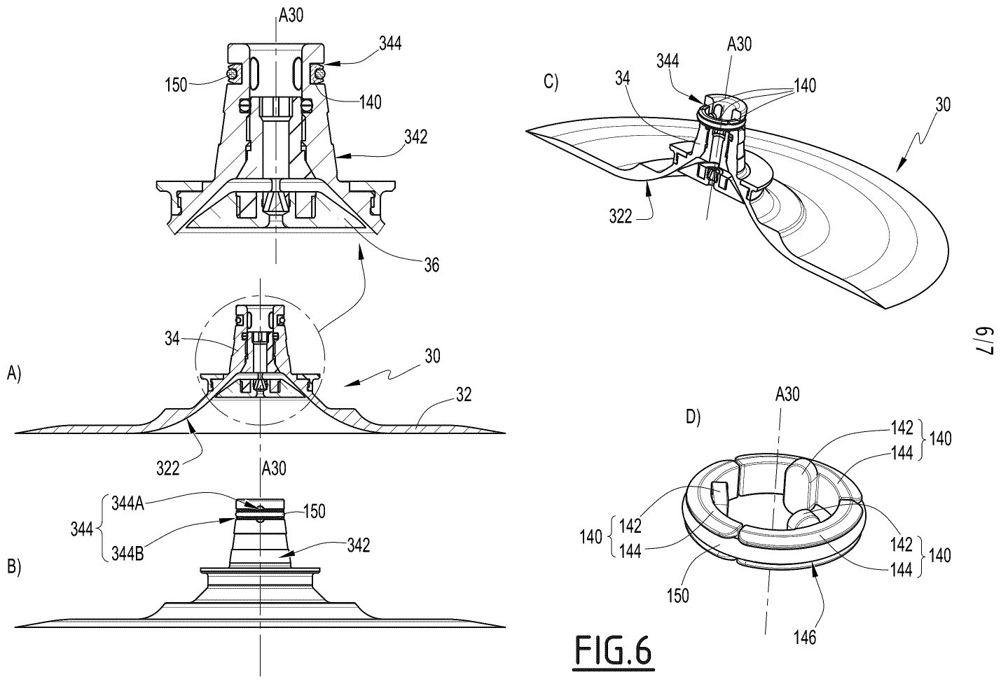

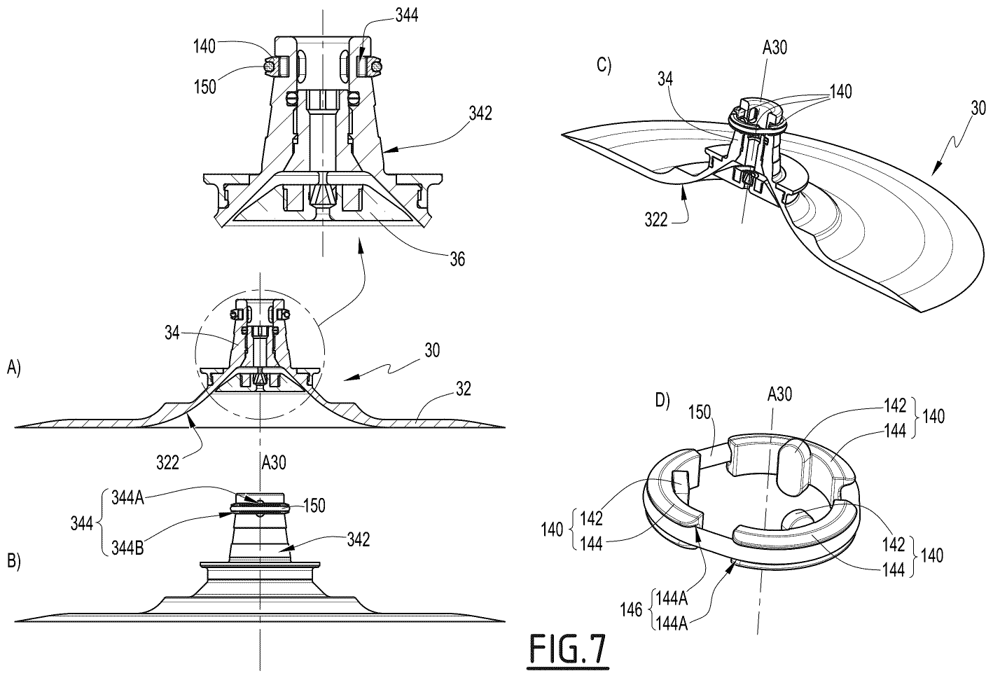

In the third embodiment shown in FIGS. 6 and 7, the spraying member 30 is a spray disk which also comprises a front portion 32 and a hub 34 which define three housings 344 each formed by two portions 344C and 344D.

The weights 140 are identical to those of the second embodiment and each comprises a heel 142 and a segment 144.

The housings 344 are identical to those of the second embodiment and each comprises a first central portion 344C and a second peripheral portion 344D.

Each segment 144 defines a peripheral groove 144A which constitutes part of an annular groove 146. An O-ring 150 is engaged in this annular groove as visible, in particular, on inserts D in FIGS. 6 and 7.

In the resting configuration shown in FIG. 6, the weights 140, and in particular their segments 144, do not project radially from the housings 344, beyond the peripheral surface 342, so that they do not oppose the positioning of the spray disc 30 on the rotating shaft of a projector comparable to the projector of the first and second embodiments.

In the configuration shown in FIG. 7, the spray disc 30 is assumed to be rotating, to the extent that centrifugal force exerts on the weights 140 a force radial to the central axis A30 which causes the segments 144 to partially exit the housings 344, more particularly from the second portions 344D of these housings, so that these segments oppose a withdrawal of the spray disc relative to the rotating shaft of the projector, according to an operation comparable to that described above concerning the second embodiment.

As can be seen from insert D in FIG. 7, under the action of centrifugal force, the segments 144 of the weights 140 may no longer be joined, while they are in the unlocked configuration of FIG. 6.

In practice, in the second and third embodiments, the O-ring 50 is made of an elastomer, in particular fluororubber of the type FKM, nitrile, ethylene-propylene-diene monomer (EPDM) or another rubber.

As an alternative of the invention, not shown, in the second and third embodiments, the O-ring 50 can be replaced by an elastically deformable cord, a rod, square or other cross-section and solid or hollow cross-section.

According to another alternative of the invention, not shown, an elastic return means comparable to the O-ring 150 can be used in the first embodiment.

According to an alternative of the invention, not shown, in the second and third embodiments, the weights 140 are devoid of the heel 142. In this case, the housings 344 are devoid of a first central portion 344C, and the weights 140 are not guided, in radial translation relative to the central axis A30, by the cooperation of the parts 144 and 344D, accommodating a possible rotation of segments 144 about the axis A30.

According to another alternative, no elastic return member is provided for the weights 140 in their unlocked configuration. In other words, the O-ring 150 is not present in the second and third embodiments.

The shape of the weights shown in the figures is not limiting, and the weights can take on other shapes, compatible with their displacement between their unlocked and locked positions under the effect of the centrifugal forces due to the rotation of the spraying member 30. The shape of the housings 344 is adapted to that of the weights 40 and 140. For example, the weights can take one of the following shapes: parallelepiped, ogive or semi-spherical.

According to an alternative, not shown, of the invention, each weight is formed by a part integral with the hub 34. Such an integral part may be produced by machining the hub or by additive manufacturing and is connected to the hub by an elastically deformable tongue which is also integral with the hub, which connects the weight to a principal part of the hub and which allows the weight to displace radially to the central axis A30 under the effect of centrifugal force, when the spraying member is driven in rotation about its central axis A30.

The invention is described above in the case where a magnetic coupling force E1 is used to clamp the spraying member 30 onto the rotating shaft 16 and where the locking obtained with the weights allows the intensity of this force E1 to be limited.

According to an alternative of the invention, not shown, the coupling in rotation of the bowl and the rotating shaft is obtained by screwing. In this case, the locking obtained with the weights allows the screwing torque required to couple the bowl and the rotating shaft to be limited.

According to another alternative of the invention, not shown, the coupling in rotation of the bowl and the rotating shaft is obtained by quarter-turn locking, in particular with bayonets. In this case, the locking obtained with the weights allows to limit the torque to be applied to couple the bowl and the rotating shaft.

According to another alternative of the invention, not shown, the coupling in rotation of the bowl and the rotating shaft is obtained by clipping, in particular according to the technical teaching of WO94/12286A. In this case, the locking obtained with the weights allows the rigidity of a clipping member to be limited, which facilitates the positioning of the bowl on the rotating shaft.

In all cases, the locking obtained with the centrifugal weights allows the coupling of the bowl to the rotating shaft, achieved by other magnetic and/or mechanical means, to be more reliable.

Alternatively, and irrespective of the embodiment, the projector 2 is of the externally charged electrostatic type and comprises a high-voltage unit and charging electrodes, not shown, configured to raise to a given electrical potential the coating product sprayed by the projector 2.

According to a further alternative applicable to all the embodiments, the projector 2 is not of the electrostatic type.

Alternatively, instead of a single annular permanent magnet 22, several permanent magnets distributed about the axis of rotation can be used as magnetic coupling means.

The invention is described above in the context of its use for spraying liquid coating product. It also applies to the spraying of powder coating products.

Any feature described for one embodiment or alternative in the foregoing may be implemented for the other embodiments and alternatives mentioned above, insofar as technically feasible.

1. A spraying member for a rotary projector for a coating product, wherein the spraying member carries at least one mechanical locking weight on a drive shaft of the rotary projector, each mechanical locking weight being movable, radially to the central axis of the bowl and according to a centrifugal direction relative to this axis, between an unlocked position, where it does not oppose mounting of the spraying member on the drive shaft or its dismantling relative to this shaft, and a locked position, where it opposes dismantling of the bowl relative to the drive shaft.

2. The spraying member according to claim 1, wherein the spraying member is equipped with first magnetic coupling means configured to cooperate with complementary second magnetic coupling means to exert an at least partial axial force relative to a central axis of the bowl.

3. The spraying member according to claim 1, comprising a plurality of mechanical locking weights distributed about the central axis.

4. The spraying member according to claim 3, wherein said mechanical locking weights are distributed about the central axis in a regular pattern.

5. The spraying member according to claim 1, wherein the spraying member comprises a hub, wherein a weight is received in a housing formed in said hub and opening onto an external radial surface of said hub and wherein, in its unlocked position, the weight is completely enclosed in the housing, and in its locked position, the weight projects from the housing beyond the external radial surface of said hub.

6. The spraying member according to claim 5, wherein a hole through which the housing opens onto the external radial surface of said hub has dimensions preventing the weight from exiting the housing through this hole.

7. The spraying member according to claim 5, wherein the weight comprises a segment for axial bearing against the drive shaft, and wherein the housing comprises a portion of a groove arranged on the external radial surface of said hub.

8. The spraying member according to claim 7, wherein the portion of a groove extends, according to a direction orthoradial to the central axis of the bowl, on either side of another portion of the housing in which a heel is engaged for guiding the weight.

9. The spraying member according to claim 1, wherein the spraying member comprises a hub and wherein each of said at least one mechanical locking weight is formed by a part, integral with said hub and movable from its locked position and toward its unlocked position by elastic deformation of a part of said hub, under the effect of inertia, when the spraying member is driven in rotation about its central axis.

10. The spraying member according to claim 1, wherein the spraying member comprises a means for elastically returning each of said at least one mechanical locking weight toward its unlocked position.

11. The spraying member according to claim 10, wherein said elastic return means comprises an elastically deformable ring which surrounds a hub of the spraying member, at the level of said at least one mechanical locking weight along the central axis of the bowl.

12. The spraying member according to claim 11, wherein each of said at least one mechanical locking weight comprises a segment for axial bearing against the drive shaft, wherein the housing comprises a portion of a groove arranged on the external radial surface of the hub, and wherein said elastically deformable ring bears on an external radial surface of each segment.

13. A coating product rotary projector comprising:
a spraying member according to claim 1; and
a drive shaft for driving in rotation said spraying member about an axis of rotation, wherein each mechanical locking weight of said spraying member is brought into its locked position due to rotation of said spraying member by the drive shaft.

14. The projector according to claim 13, wherein said drive shaft defines a bearing relief on which each of the at least one mechanical locking weight of said spraying member in the locked position bears.

15. The projector according to claim 14, wherein the bearing relief is an internal shoulder of said drive shaft.
